(19) United States
(12) Patent Application Publication
(10) Pub. No.: US 2006/0026007 A1
(43) Pub. Date: Feb. 2, 2006

(54) System and method for end-users to customize customer service business solutions offered as a service over a network

(76) Inventor: Dimitri J. Stephanou, Tampa, FL (US)

Correspondence Address: DIMITRI J. STEPHANOU, 19138 MEADOW PINE DRIVE, TAMPA, FL, 33647, US

(21) Appl. No.: 10/710,644

(22) Filed: Jul. 27, 2004

(51) Int. Cl. G06Q 99/00

(52) U.S. Cl. 705/1

(57) ABSTRACT

A system and method for end-users to customize customer service business solutions offered as a service over a network. The invention allows end-users to select and customize over a network a customer service business solution from a number of such business solutions offered by the vendor. It allows users to customize the selected business solution to their own business environment without the need for them to change any of the underlying programming code of the business solution. The system of the present invention is used for a variety of customer business solutions.

### CROSS REFERENCE TO RELATED APPLICATIONS

U.S. Pat. No. 6,513,013—. entitled “System and method for providing expert referral over a network with real time interaction with customers”, is related to the present application and is incorporated herein by reference in its entirety.

### BACKGROUND OF INVENTION

Small to medium organizations are currently locked out from customer service enterprise software because of the relatively high cost to acquire and implement such software and their lack of resources to configure, customize and maintain such applications. Although some vendors are currently offering customer service enterprise software in a hosted or ASP model, such offerings have not adequately addressed the needs of small and medium organizations for low cost, user customizable, and industry specific solutions with quicker visible results. No vendor currently offers customers over the Internet a rapid and easy way to select, configure and customize to their own environments customer service enterprise software that cater to specific business needs.

The present invention seeks to cater to those needs by delivering web-based client configurable and customizable customer service enterprise business solutions in a service based model. It allows end users to customize to their own environment any of a number of web-based customer service business solutions in few simple steps, in a matter of few minutes. The present inventions thus makes it very easy to acquire, customize and run as a service customer service business applications “on the fly” with no need to have the internal IT resources to “program” those customizations or the equipment to run and support those business solutions. Furthermore, those customizations done by the end user without having to make changes to the code are stored in database files and are thus carried by future releases.

The present invention is used as follows. A user within an organization, typically one with decision-making authority, identifies a business need within the organization. The user goes to a central location on the network where a number of software business solutions are offered as a service. The user then proceeds to provide information that allows the system to customize the business solution to cater to the organization's needs.

As a first step, the user enters information about the organization, selects the softtware business solution of interest, attaches the organization's logo, customizes a number of field labels and creates an administrator account.

Next, the user logs in as the administrator to continue with the configuration and customization of the business solution.

After logging-in as the administrator the user proceeds to add additional users to the system. Once adding users is done, the administrator has the option to have the system automatically email all users their login-credentials.

Next, the user proceeds to add service categories and service sub-categories to the business solution.

Next, the administrator proceeds to add experts and assign those experts to specific service categories and subcategories. The user also activates the experts and makes them available in the corresponding service categories and sub-categories.

In summary the present invention is a tool that empowers users to rapidly customize business solutions and run them as a service over the Internet with no need to acquire any physical software and without any programming know-how.

### SUMMARY OF INVENTION

The present invention provides a system and method for end-users to select, configure and customize customer service business solutions offered as a service over a network.

### BRIEF DESCRIPTION OF DRAWINGS

FIG. 1A illustrates the architecture of the present invention.

FIG. 1B illustrates the overall sign-up, configuration and customization flow of the present invention.

FIG. 2 illustrates the login screen for users to access the business solutions. New users would use the “Click here to create a custom business solution!!” link to create and customize a new business solution for their organization.

FIG. 3 illustrates a screen consisting of a data entry sheet requesting a plurality of answers pertaining to creating and customizing the business solution. The user is asked to enter information about the client organization the user belongs to, select a business solution from a list of several solutions provided and customize the solution by attaching an organization logo and specifying some field labels. The user also creates an admin account that is needed to continue with the customization of the selected business solution.

FIG. 4 illustrates confirmation screen that summarizes the information that was entered in the previous step and allows the user to continue to the following step.

FIG. 5 illustrates a screen in which the user logs in into the system with the newly created admin credentials.

FIG. 6 illustrates a screen consisting of a segmented multi-step menu sheet that allows the admin to add or edit user information, service category information and expert service provider information pertaining to customizing the business solution.

FIG. 7 illustrates a screen consisting of a data entry sheet requesting a plurality of answers pertaining to adding users to the business solution. The sheet also provides a link that allows the newly added users IDs and passwords to be emailed to them.

FIG. 8 illustrates a screen consisting of the segmented multi-step menu sheet in FIG. 6 with a check mark next to the “Add Users” section representing that the step of adding users has been completed.

FIG. 9 illustrates a screen consisting of a data entry sheet requesting a plurality of answers pertaining to adding categories to the business solution.

FIG. 10 illustrates a screen consisting of a data entry sheet requesting a plurality of answers pertaining to adding sub-categories to the newly added category.

FIG. 11 illustrates a screen that confirms the category and corresponding sub-category added in the previous screens. The screen also provides a link to go to the category administration screen illustarted in FIG. 12.

FIG. 12 illustrates the category administration screen consisting of a data entry sheet requesting a plurality of answers pertaining to activating or deactivating categories and sub-categories, edit category and sub-category names, and add more sub-categories to a selected category. Users can access this screen from the link in FIG. 11 or by clicking on the “Edit Category” button on the segmented multi-step menu illustarted in FIG. 8.

FIG. 13 illustrates a screen consisting of the segmented multi-step menu sheet illustrated in FIG. 8 with a check mark next to the “Add Categories and Sub-Categories” section representing that the step of adding categories and sub-categories has been completed.

FIG. 14 illustrates a screen consisting of a data entry sheet requesting a plurality of answers pertaining to the first step of adding service experts to the business solutions.

FIG. 15 illustrates a plurality of categories that can be assigned to the expert.

FIG. 16 illustrates a plurality of sub-categories that can be assigned to the expert.

FIG. 17 illustrates a confirmation screen that shows that the service expert information has been successfully submitted. The screen also has a link to the “Expert Detail” screen illustrated in FIG. 18.

FIG. 18 illustrates a screen consisting of a data entry sheet requesting a plurality of answers pertaining to activating and making the expert available to accept service requests, changing the Expert's area of expertise, and changing other information pertinent to the expert.

FIG. 19 illustrates a screen that allows an expert to be activated in a certain sub-category or allows a sub-category to be deleted as an area of expertise for the expert. The screen also has a link to the screen that allows categories to be added as expertise areas for the expert illustarted in FIG. 15.

FIG. 20 illustrates a screen consisting of the segmented multi-step menu sheet illustrated in FIG. 13 now with a check mark next to the “Add Experts” section representing that the step of adding Experts has been completed.

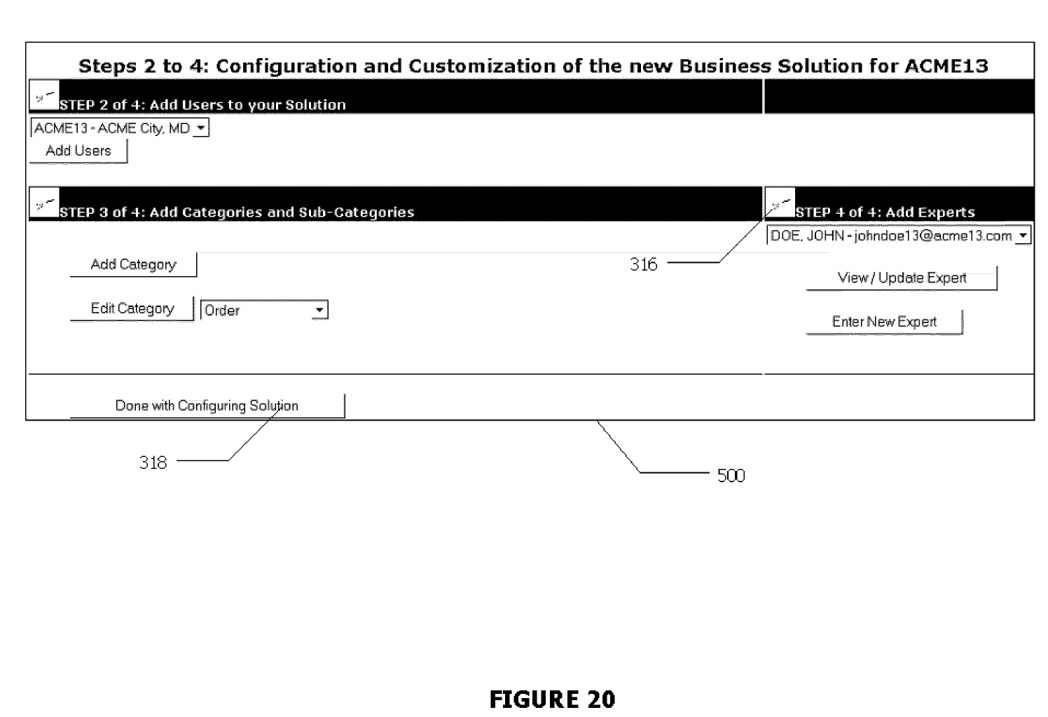

FIG. 21 illustrates the login screen for users to access the newly created and customized business solution.

FIG. 22 illustrates the system administration login screen for the sysetm admin to make ongoing changes and administer the business solution.

FIG. 23 illustrates the sysetm admin menu where the system admin makes changes and administer the business solution.

### DETAILED DESCRIPTION

Terminology

The terms “client” shall be taken to refer to any organization, private, government or public that participates in a transaction, communication or process, for the purpose of supporting its customers.

The term “customer” shall be taken to refer to any entity, human or automated, that participates in a transaction, communication or process for the purpose of communicating with the client.

The term “admin” or “administrator” shall be taken to refer to any entity, human or automated, that is affiliated with the client and participates in a transaction, communication or process through the present invention to configure and customize a customer service business solution that can be used by the client to communicate and service its customers.

The term “solution” shall be taken to refer to any software application that is used by an organization to solve challenges in their customer service workflow and in the process improve the quality and response-time of their customer service.

The term “expert” shall be taken to refer to any entity, human or automated, affiliated with the client that participates in a transaction, communication or process to provide customer service support in an expert capacity to the organization's customers.

Description

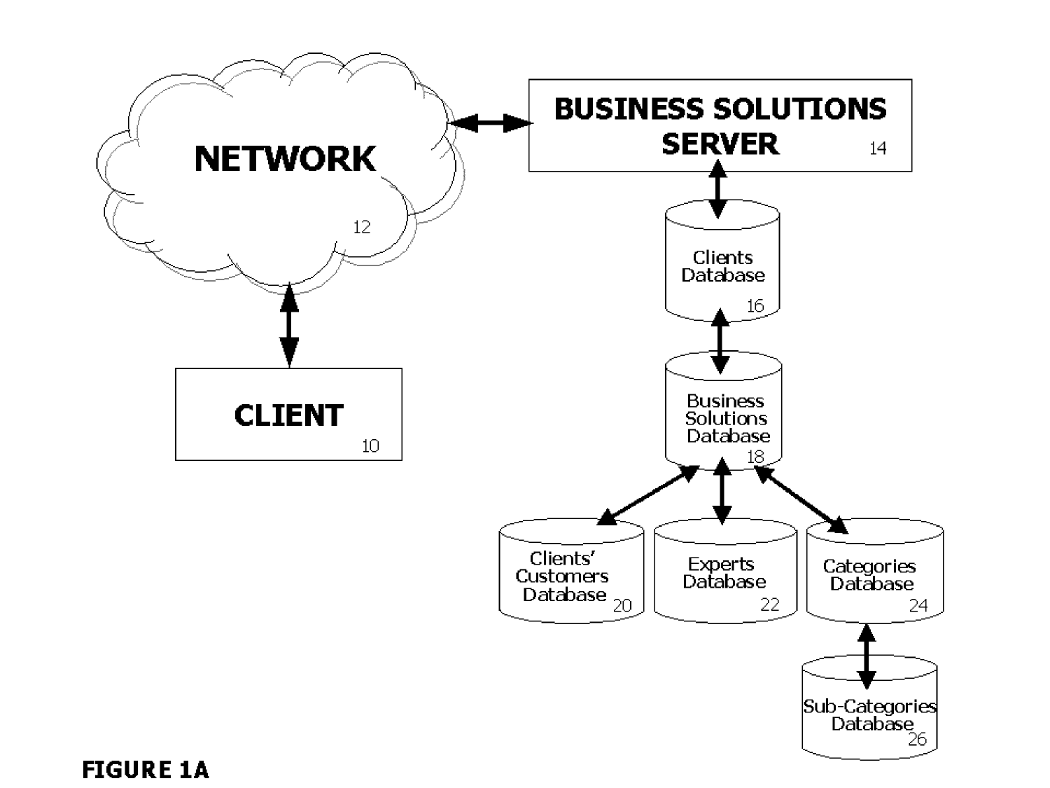

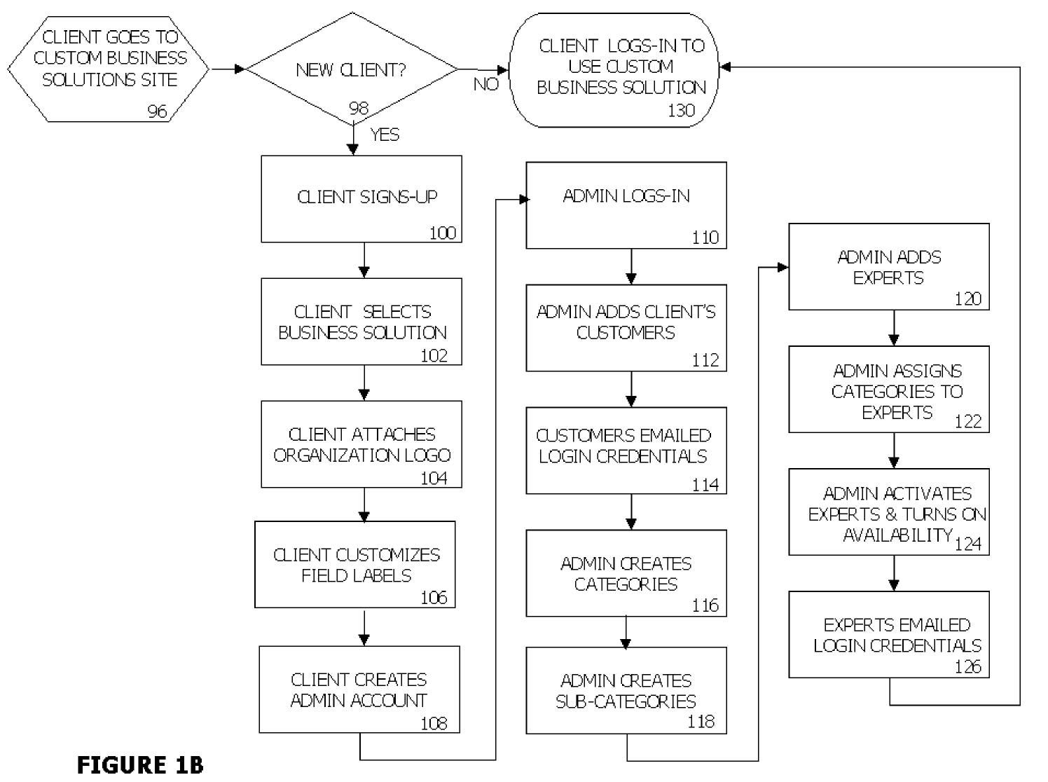

Referring to FIG. 1A, the overall architecture of the present invention is illustrated. A client, here shown simply as client 10 may wish to use a customized business solution to communicate and service its customers. Client 10 uses a network 12, preferably the Internet although this is not meant as a limitation, to go to the business solutions server 14. The business solutions server 14 accesses a number of databases that pertain to customizing and later using those solutions. Those include, but are not limited to, a clients database 16 where pertinent data about the clients who use the business solutions to service their customers reside, a business solutions database 18 where pertinent data about the business solutions offered reside, a clients' stomers database 20 where pertinent information about the client's customers reside, an expert database 22 where pertinent information about the client's customer service reproviderseside, and a categories database 24 and sub-categories database 26 where pertinent information about the client's serviced categories and sub-categories reside.

Referring now to FIG. 1B, the overall client sign-up, selection and customization of the customer service business solutions flow of the present invention is illustrated. When a new client accesses the business solutions site 96, the client is directed to sign-up 100. An existing client can login and start using the customer service solution that has already been customized 130.

Once the client signs-up the organization, the user is asked to select a customer service business solution to be customized to cater to the organization's specific business needs 102.

The client then proceeds to customize the business solution's logo banner by attaching the organization's logo that would be displayed throughout the application when used 104.

After signing-up and customizing the logo banner and field labels, the client proceeds to create an administration (admin) account 108 and then use this admin account to login and continue with the customization of the business solution 110.

Upon login, the client admin will go through the remaining series of steps to complete the customization of the business solution. The admin will first add the customers (users) 112 who will be using the customer service solution to communicate with the client's representatives (experts). Once the customers are added, the admin instructs the server to send their login credentials through automated email messages 114.

The client admin next moves to the next step of creating the service categories 116 and service sub-categories 118. As an example, but without limitation, the client admin might create a category of “Clinical Trial 123” and 2 corresponding sub-categories of “Report Adverse Event” and “Contact CRA” for a clinical trials business solution that the client if customizing.

As a next step, the client admin adds the client's representatives (Experts) that will communicate and service the customers 120 and assigns the appropriate categories and sub-categories to each expert 122. For example, but without limitations, the client admin might add an expert “John Doe” and assign “Microsoft” and “Exchange” as the expert's category and sub-category areas of expertise respectively.

Next the client admin activates the experts and turns-on their availability if applicable 124. Finally the client admin emails the experts their login credentials 126 which they can use to login to the customized business solution 130.

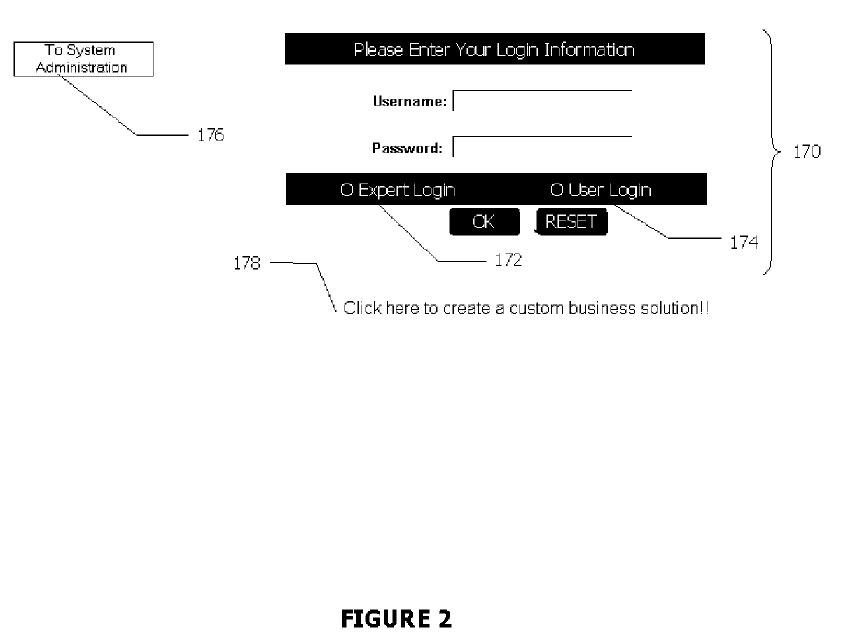

Referring now to FIG. 2 the main login screen is illustrated. For new clients, a link 178 below the login form 170 allows them to navigate to the various steps of the present invention where they can configure and customize the customer service solution that caters to their specific business environment. Existing clients (Experts) 172 and their customers (Users) 174 would use the login form 170 to access the customized solution and the client administrator would use the “To System Administration” button 176 to access the administration functions of the business solution.

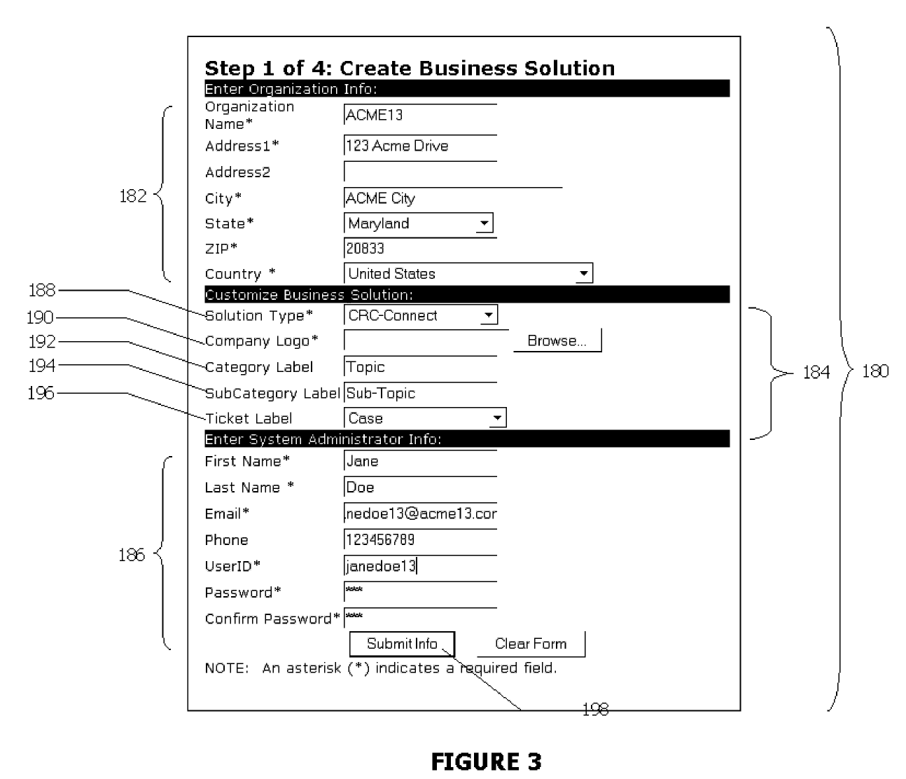

In FIG. 3 the new client sign up data entry sheet (form) 180 of the present invention is illustrated. The sign-up form 180 consists of, but is not limited to, 3 sections. The first section 182 consists of information relevant to the client organization. As an example and without limitations, the organization info section 182 includes data entry information for the name and complete address of the client organization.

The second section 184 of sign up form 180 consists of information relevant to the top-level selection and customization of the customer service business solution of interest. In this section the client selects form a drop-down menu a business solution that caters to its specific customer service needs 188. As examples and without limitation such customer service solutions include a helpdesk solution, a generic customer service solution, a solution catered to the medical community, a solution catered to supporting clinical trials, a solution catered to support the linguistic community and other customer service applications that have been made available as client customizable solutions through the present invention.

In section 184, the client can also customize the business solution's logo banner by attaching the organization's logo 190 that would be displayed throughout the customer service application. Other customizations possible in this section include, but are not limited to, customizing the field labels of the category 192, sub-category 194, and ticket 196 fields that are used in the customer service applications. As an example but without limitation, the client might name the label for a ticket 196 that is opened by a user when communicating with a customer service representative a “Ticket”, a “Case”, an “Incident”, an “Inquiry”, or any other term that the client likes to use in the customized service application. Similarly the client can customize the labels of the category field 192 and of the sub-category field 194 to cater to the business solution that is being customized and to the organization's preferences. As examples but without limitation, for a medical customer service solution, the client might name the labels of the category and sub-category data fields as “Doctor” and “Question Type” respectively or for a linguistic service solution “Language” and “Dialect” respectively.

In the third section 186 of data entry sheet 180, the client creates an Administrator (admin) account that will be used to continue with the configuration and customization of the customer service business solution. As examples but without limitation, information entered to create the admin account includes the name, email address, phone number, userID and password.

When all 3 sections in data entry sheet 180 are completed, the client submits the information entered into the corresponding database tables by clicking in the submit info button 198. Upon submitting the information in form 180, a new customized business solution is created in the business solutions database. A new client is also created in the clients' database and exclusive ownership of this new customized business solution is given to the client. From here on, any additional customizations or configurations made to this client's business solution by the client's admin will be only reflected in this particular client's solution and not in any other client's solution.

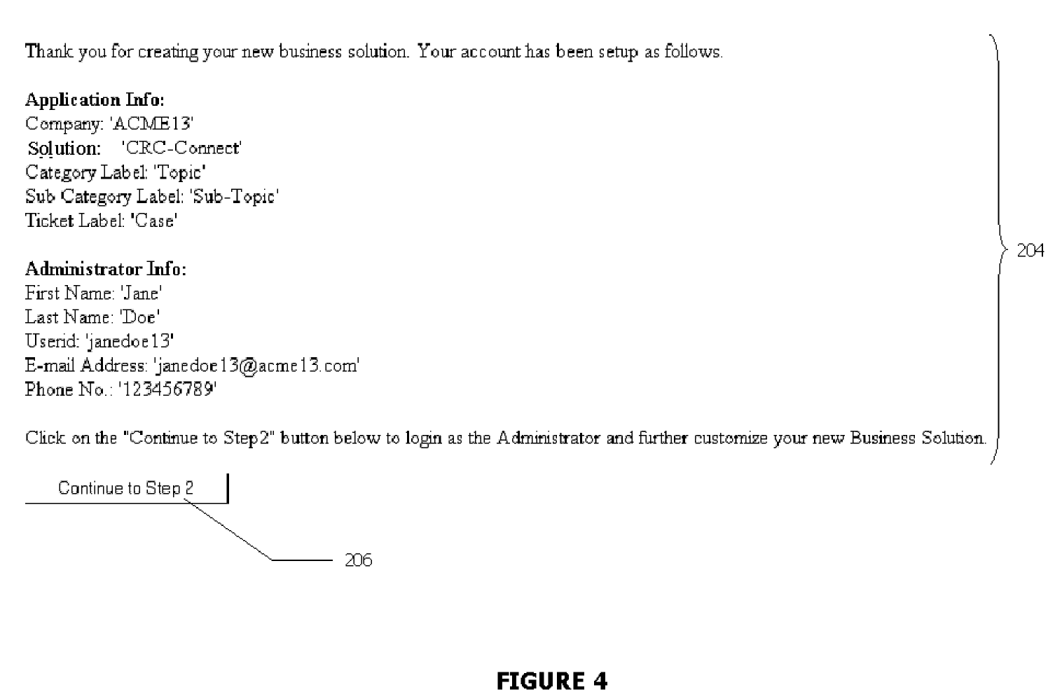

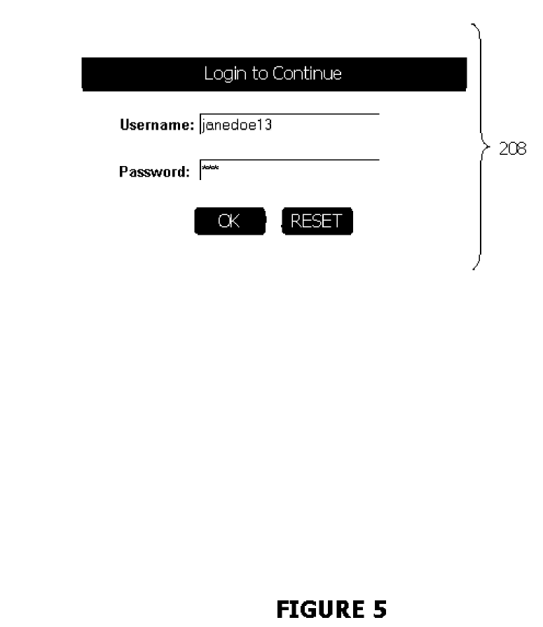

In FIG. 4 a summary 204 of the newly created custom business solution is illustrated. By clicking on the continue button 206, the client navigates through the other customization steps of the present invention which require the client to login with the administrator account created earlier 186. FIG. 5 illustrates the administrator login form 208 where the client enters the userID and password of the administrator account and clicks the OK button to proceed.

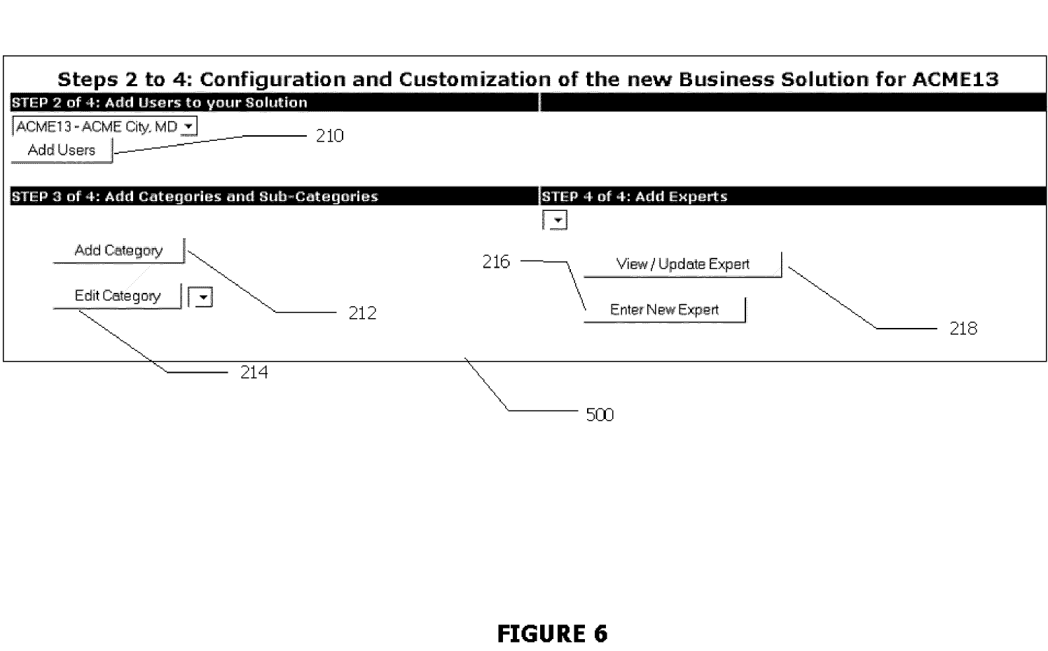

In FIG. 6 a screen of additional customization steps is illustrated. As an example and without limitation, FIG. 6 shows a dashboard with 3 main sections of additional customizations 500. Those sections include one for the client to add/modify customers (users) 210, one for the client to add 212 and modify 214 categories and subcategories for the client customers to use when communicating with the client's customer representatives and a section for adding 216 and modifying 218 customer representatives (experts).

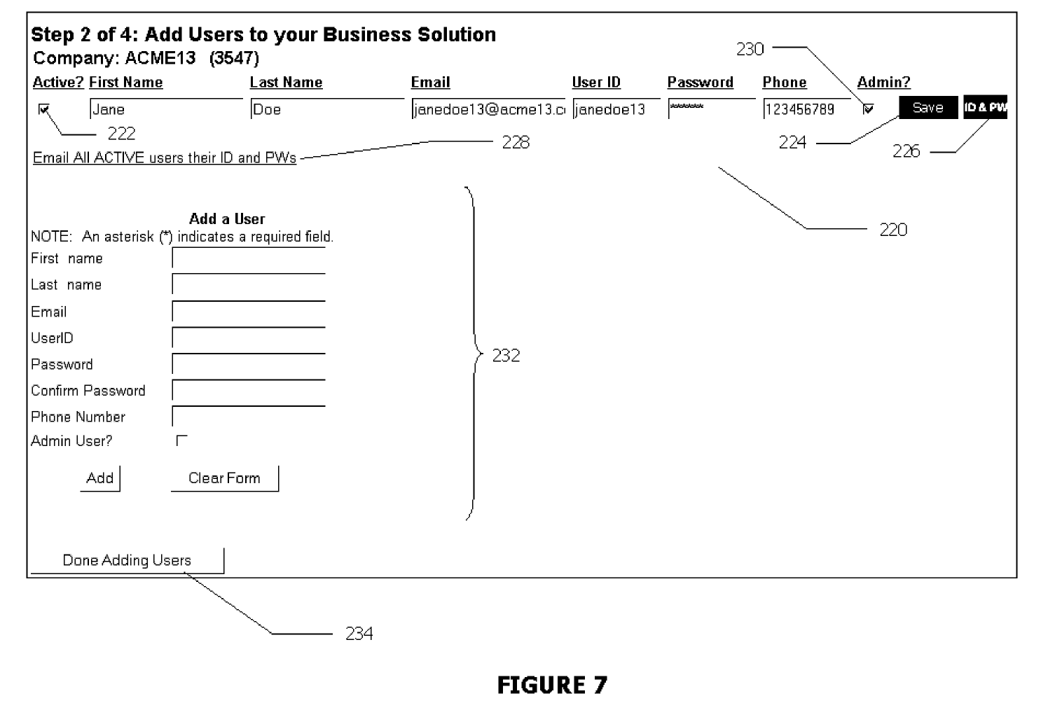

In FIG. 7 a two-part data entry sheet for adding/modifying customers (users) is illustrated. In the top part of the sheet 220, customers who already have been added as users of the customized business solution are listed. In addition to listing the customers, this section of the sheet allows the client admin to make any necessary updates to the customer's information and saving the changes by clicking on the Save button next to each customer record 224. The client can also activate or de-activating the user by clicking on the “Active” check box 222. The client can also email the userID and password of a customer whose login credentials have been changed by clicking on the “ID & PW” button 226 next to that record. When the credentials of all customers who have been added to the system need to be emailed to the corresponding users, the client can click on the “Email All ACTIVE users the ID and PWs” hyper link 228. The system also provides an option to allow the client to give limited admin user privileges to selected customers by clicking on the Admin check box 230.

The bottom part 232 of the data entry sheet in FIG. 7 illustrates how customer users are added. As the users are added using this form 232, the top part of the sheet 220 displays the new records. The “Done Adding Users” button allows the client to go back to the customizations dashboard 500.

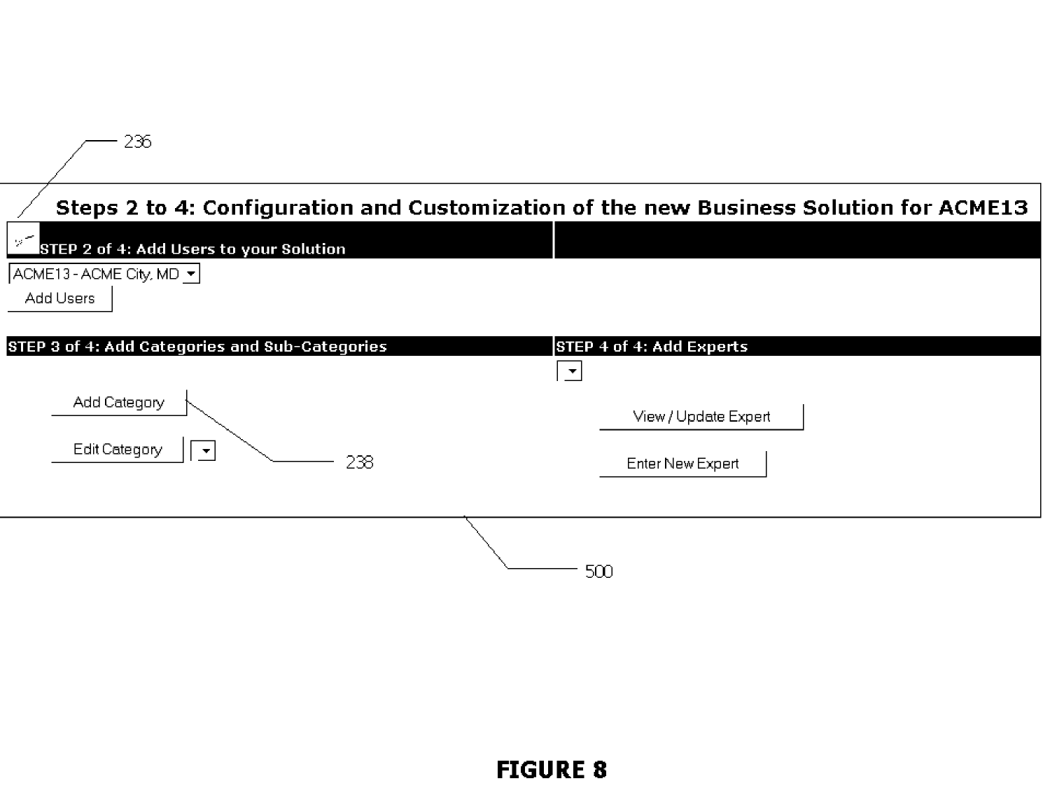

FIG. 8 illustrates the customization dashboard 500 with a check mark 236 next to the “Add Users to your Solution” section thus showing that this customization section has been completed. The client can thus now move to the next step of the customization namely adding categories by clinking on the “Add Category” button 238.

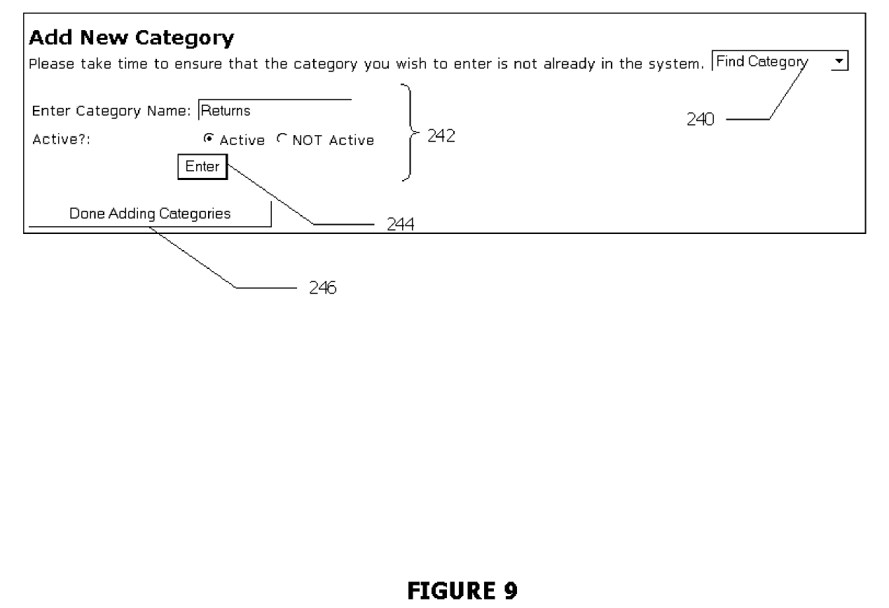

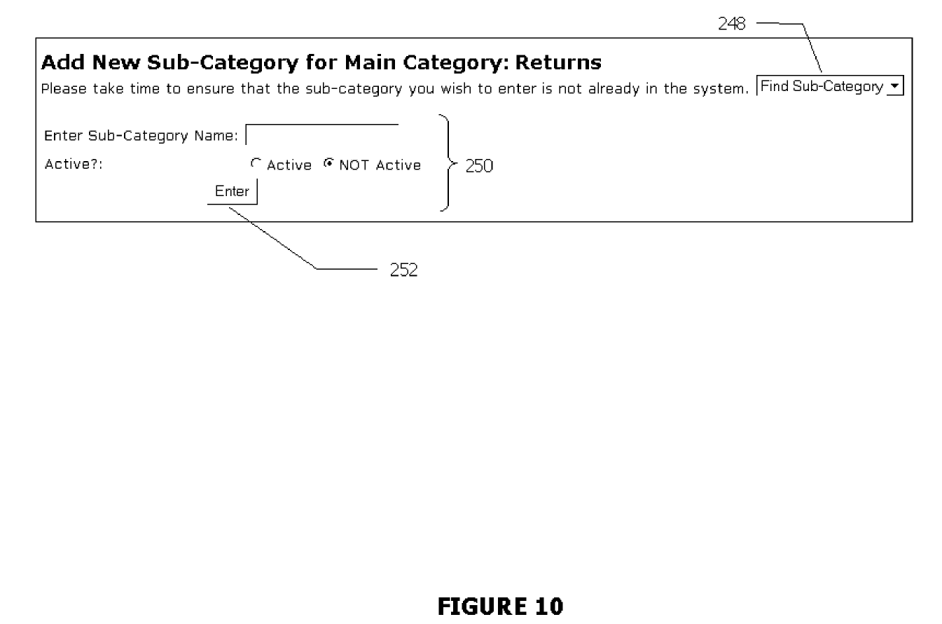

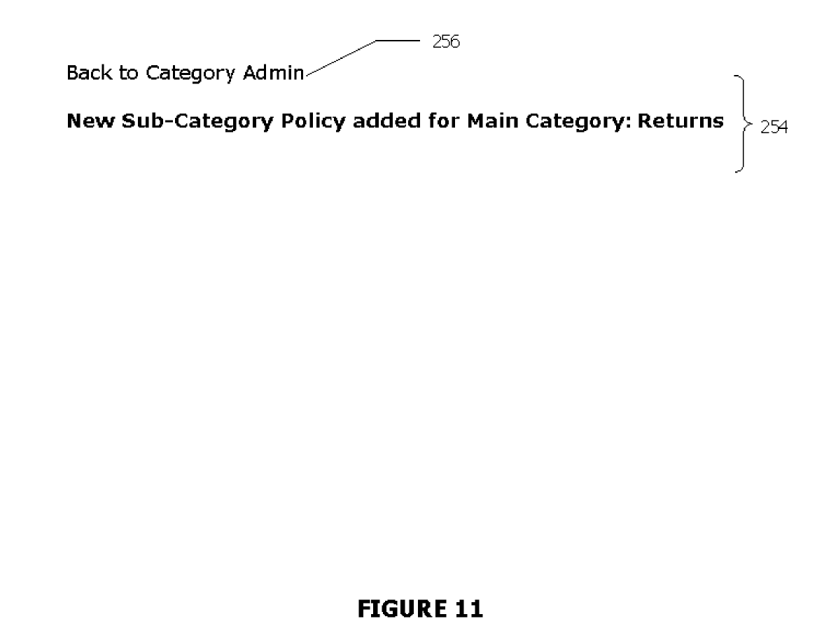

In FIG. 9 the screen to add categories to customer service business solution is illustrated. After checking that the new category to be added is not already in the system by looking in the drop-down list 240, the client uses form 242 to add the new category and make it active. After adding each new category the client clicks on the “Enter” button 244 to add the category in the categories database and go to the sub-category screen to add the corresponding sub-categories for each newly added category as illustrated in FIG. 10. When the first sub-category is added to the sub-categories database, a confirmation screen, as illustrated in FIG. 11, with summary info 254 about the category and sub-category just added is shown. The client goes to the category admin screen to add more subcategories or edit category/sub-category by clicking on “Back to Category Admin” link 256 in FIG. 11.

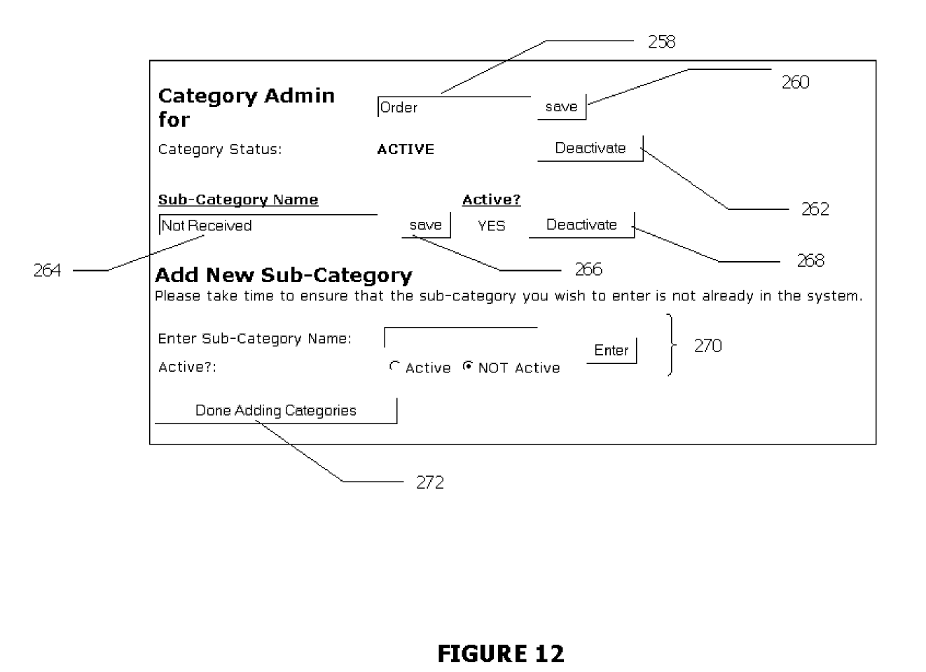

In FIG. 12 the Category Admin screen is illustrated. In this screen, the client can edit a category 258 or a subcategory 264, and save those changes by clicking on the “save” buttons 260 or 266 respectively. The “Deactivate” buttons 262 and 268 allow the client to deactivate a category or sub-category respectively. Additional subcategories can be added in 270.

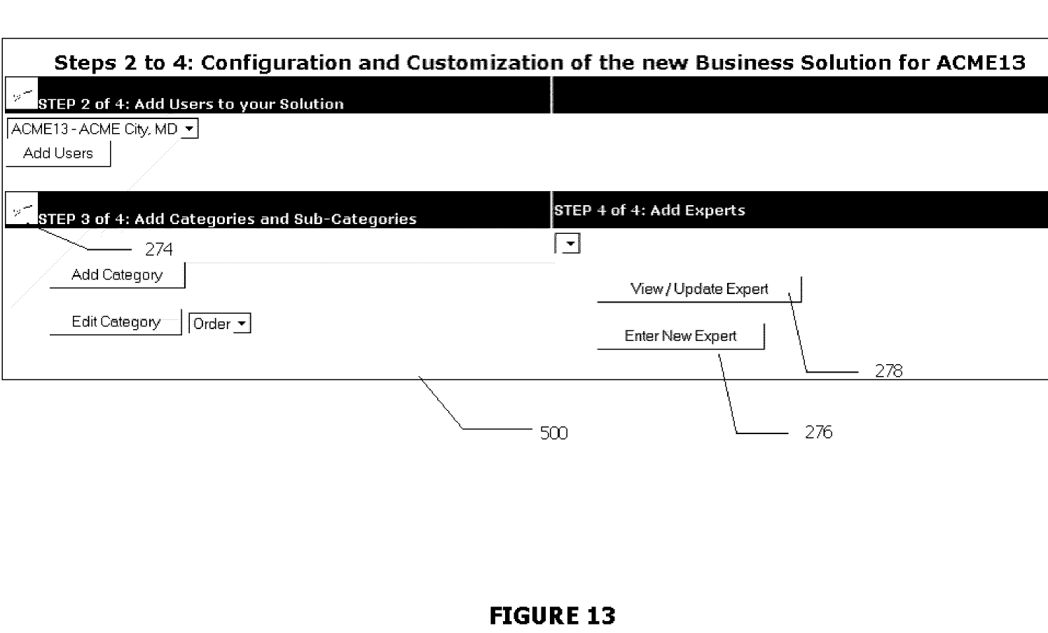

Once done adding categories, the client clicks on the “Done adding Categories” buttons 246 or 272 in FIG. 9 or FIG. 12 respectively and goes back to the customizations dashboard 500 with a check mark 274 next to the “Add Categories and Sub-Categories” section thus showing that this customization section has been completed as illustrated in FIG. 13. The client next can proceed by adding new client service representatives (experts) to the business solution by clicking on the “Enter New Expert” button 276.

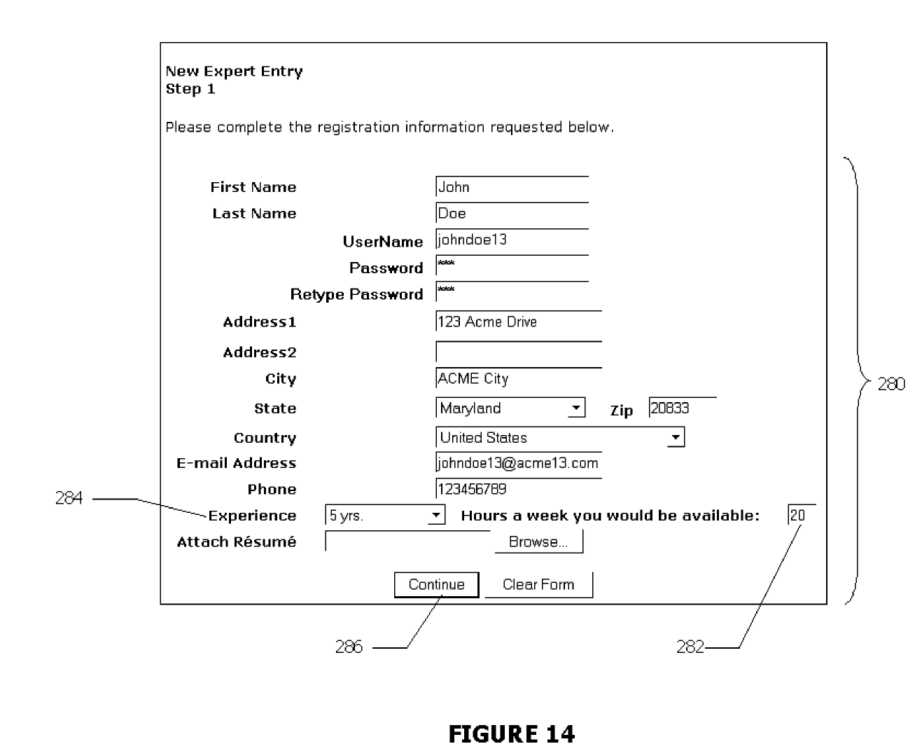

FIG. 14 to FIG. 19 illustrate the steps needed to add experts to the customer service business solution and assigning categories and sub-categories as areas of expertise to those experts.

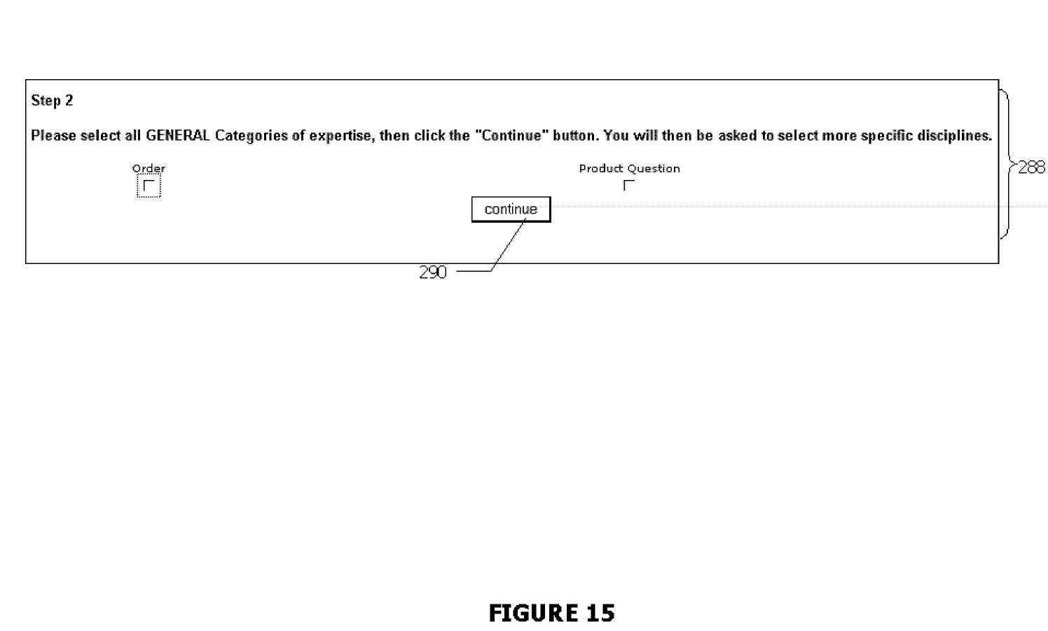

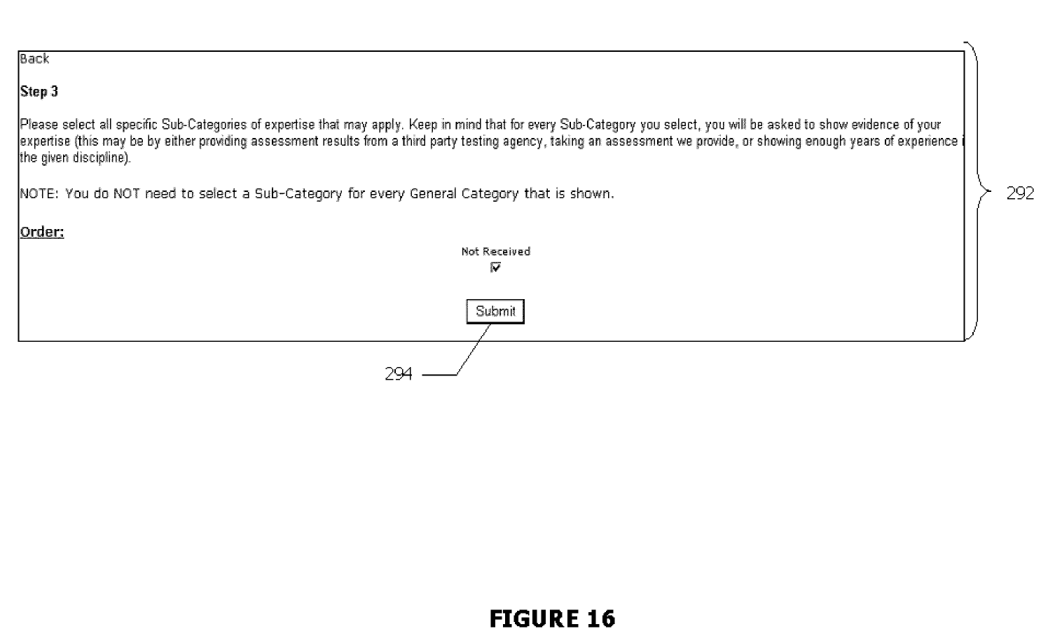

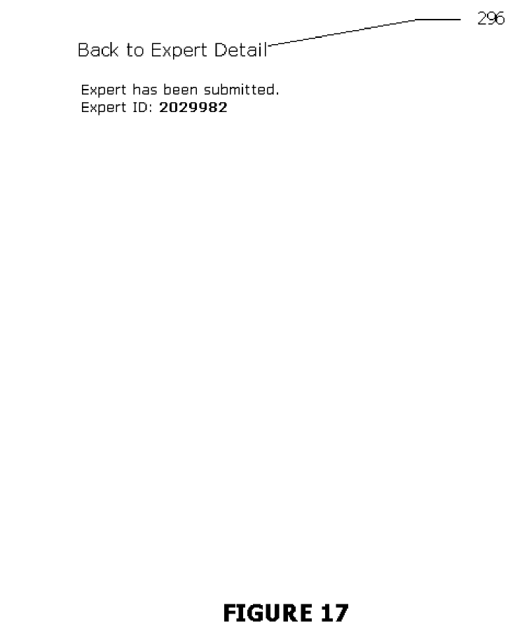

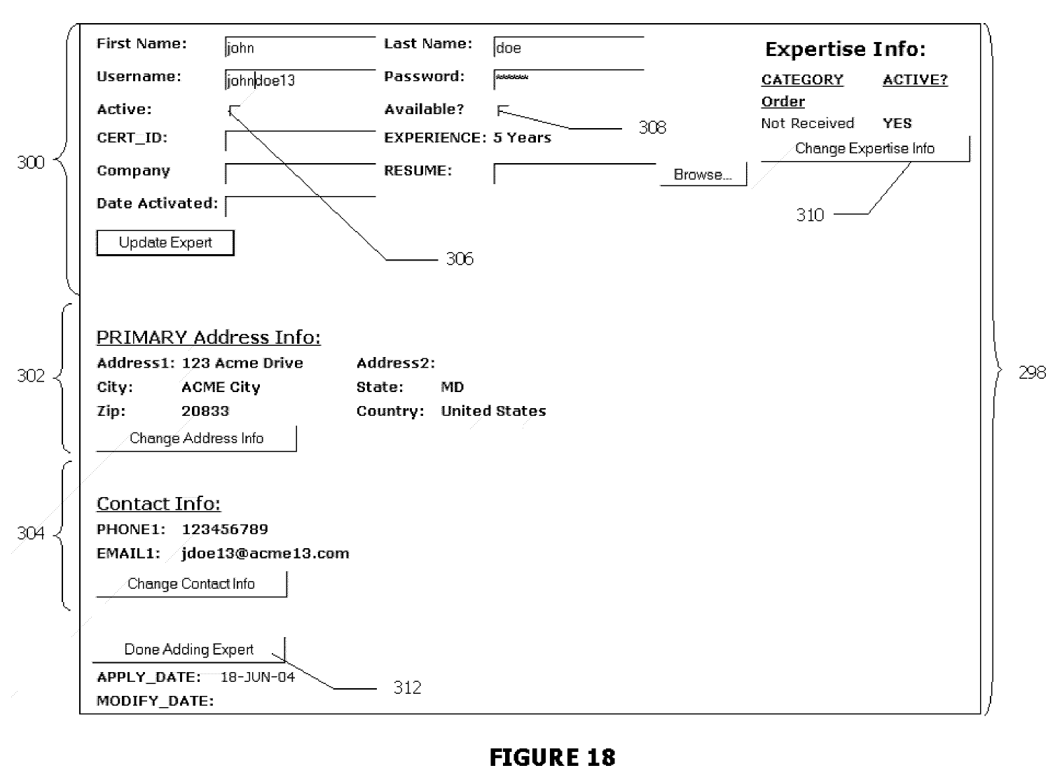

In FIG. 14 a data entry sheet for signing up 280 the client service representative (expert) is illustrated. As examples and without limitation, the data requested may include the name, address, contact information, userID, password, availability level, years of experience and resume of the expert being added to the solution. The availability level or number of hours per week the expert is available 282 and the experience level 284 are some of the factors, but not limited to, used by the system to assign priority and escalation levels for tickets being opened by customers. When the sheet 280 is filled, the client clicks on the “Continue” button 286 and navigates to the data entry sheet 288 illustrated in FIG. 15. The data entry sheet 288 provides the client with the list of categories supported by the client service solution. The client may thus assign categories that can be supported by the expert by checking the appropriate boxes next to those categories. When done with the categories assignment, the client click on the “Continue” button 290 and is taken to the subcategories assignment data entry sheet 292 illustrated in FIG. 16. When done with assigning the sub-categories the client clicks on the “Submit” button 294. FIG. 17 illustrates a screen that confirms that the new expert has been added. By clicking on the “Back to Expert Detail” link 296, the client is taken to data entry sheet 298 illustrated in FIG. 18.

In FIG. 18 a data entry sheet 298 for modifying client service representative (expert) detail information is illustrated. This sheet can be accessed through either the main customization dashboard 500 or through the “Back to Expert Detail” link 296.

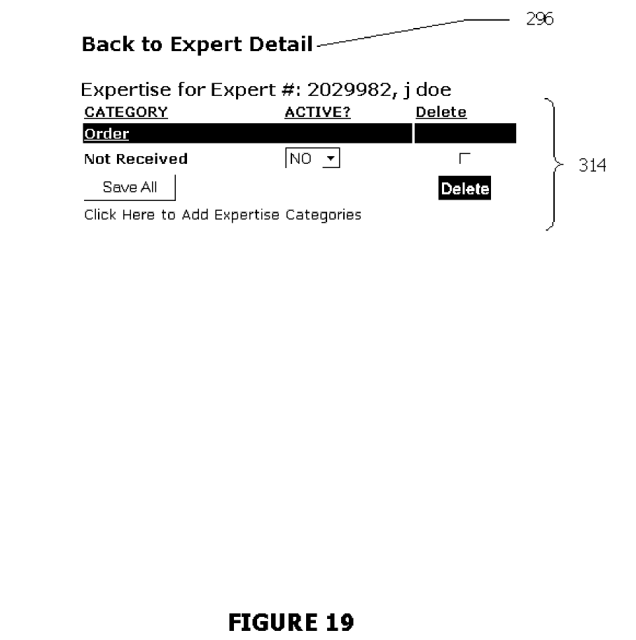

Data entry sheet 298 consists of 3 sections relevant to the expert information. Section 300 consists of general information for the expert and 2 check boxes that allow the client to activate the expert 306 and turn on the expert's availability 308 to take inquiries from customers. In addition, in this section, the client can zoom in on the areas of expertise that the expert has been assigned to by clicking on the “Change Expertise Info” button 310. When button 310 is clicked on, the client is taken to data entry sheet 314 where the client may activate, delete or add areas of expertise (assigned categories) to the expert as illustrated in FIG. 19. Sections 302 and 304 allow the client to change the address and contact information for the expert respectively. When the client clicks on the “Done Adding Expert” button 312, the client is taken back to customization dashboard 500 where now a check box 316 is shown next to the “Add Experts” section.

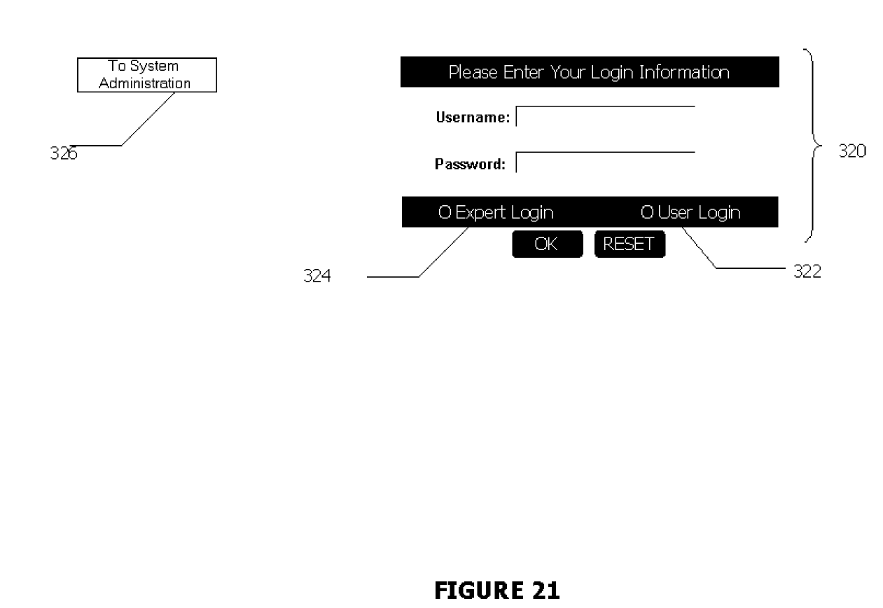

At this point the client may click on the “Done with Configuring Solution” button 318 to go to the main login screen of the solution 320 as illustrated in FIG. 21. The solution is now ready to be used by customers and client service representatives by logging into the solution with either the “User Login” radio button 322 or “Expert Login” radio button 324 enabled.

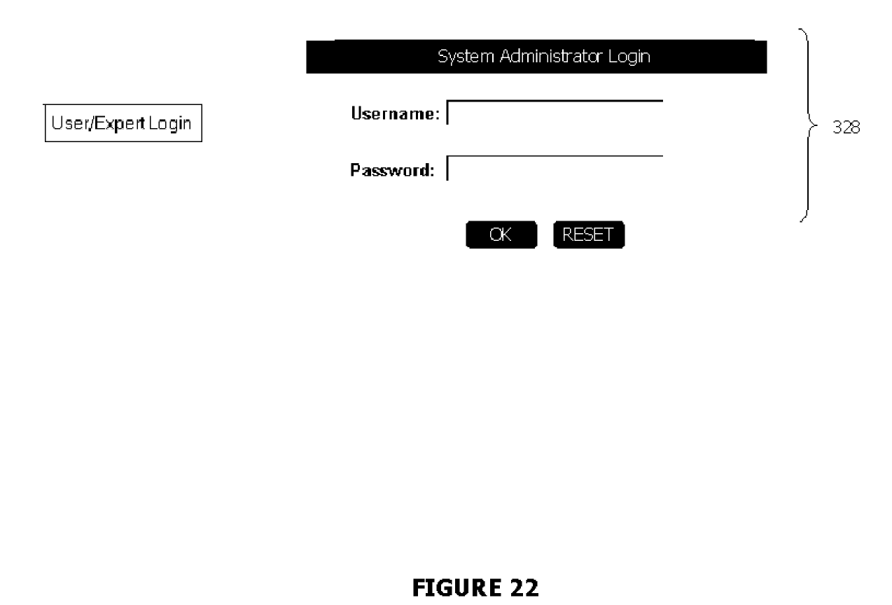

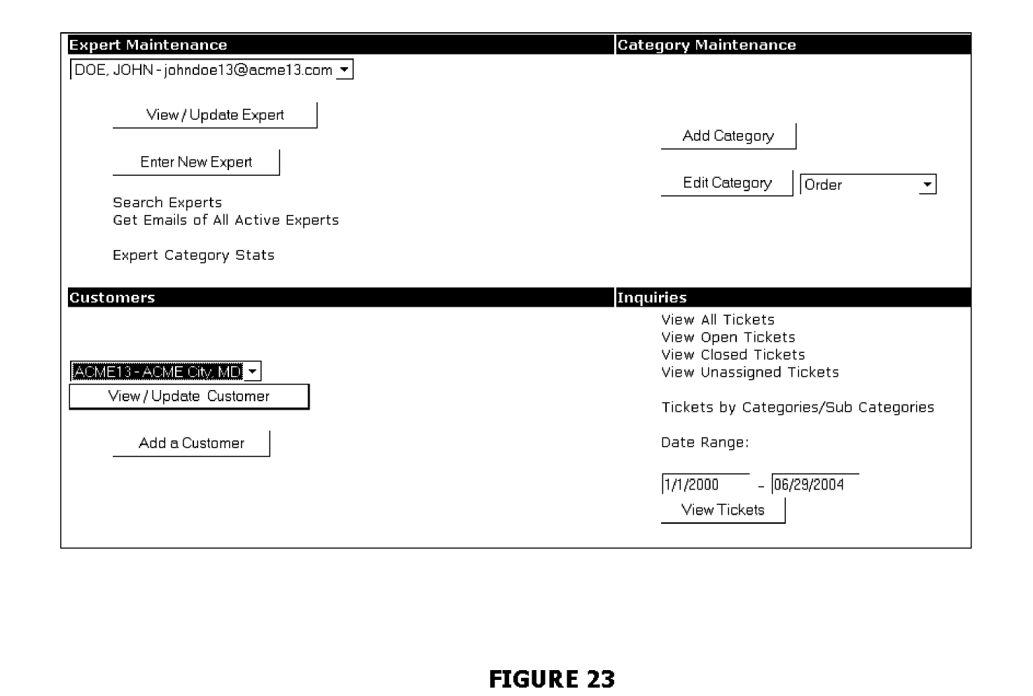

The “To System Administration” button 326 allows the client admin to navigate to login sheet 328 whn FIG. 22 ere the client admin can login to make further configuration or customizations and on-going maintenance to the business solution as illustrated in FIG. 23.

The system and method of the present invention can also be used in a general way to customize and run other type of software solutions in aover a network variety of other areas not related to customer service. Thus the customer service applapplication the present invention is not meant as a limitation but is illustrative of the concept of clients being able to select from a wide variety of customer service busisolutions customize the selected application to their specific environment via a network in a few simple steps.

It will therefore be apparent to those skilled in the art that other variations of the present invention in customizing all sort of software applications via a network can be achieved without departing from the scope of the invention as disclosed.

1. A system for generating and running custom-built software business solutions: a server further comprising a file of software business solutions; a network connected to the server for allowing access to the file of software business solutions; at least one user computer connected to the network of the system for selecting and customizing one or more software business solutions; the server further comprising customization instructions adapted to customize the software business solutions to the user's n'eds in a series of few steps; the server further comprising a file of customization parecific to each user; the software business solutions further comprising instructions to link users upon login to their own customization files;

2. The system for allowing customization of claim 1 wherein the server further comprises instructions adapted to allow the user of the system to add information about the organization the user is coming from to include the name and address of the organization in the file of clients.

3. The system for allowing customization of claim 1 wherein the server further comprises instructions adapted to allow the client to select a business solution from a list of several business software solutions resident on the file of business solutions.

4. The system for allowing customization of claim 1 wherein the server further comprises instructions adapted to allow the client to add information about the looks of the business solution to include the client organization's logo.

5. The system for allowing customization of claim 1 wherein the server further comprises instructions adapted to allow the client to customize the screen label name for the data fields of the business solution.

6. The system for allowing customization of claim 1 wherein the server further comprises instructions adapted to allow the client to customize the text fields used by the business solution to generate communication messages.

7. The system for allowing customization of claim 1 wherein the server further comprises instructions adapted to allow the client to assign an administrator for the business solution by entering information to include name, userid, password and contact information.

8. The system for allowing customization of claim 1 wherein the server further comprises instructions adapted to allow the system to display a summary of customizations that the user has performed at the end of each of the customization steps.

9. The system for allowing customization of claim 1 wherein the server further comprises instructions adapted to allow the user to login as the administrator in order to continue with the additional customization steps.

10. The system for allowing customization of claim 1 wherein the server further comprises instructions adapted to allow the administrator to add other users to the file of users and assign login and contact information for those users.

11. The system for allowing customization of claim 1 wherein the server further comprises instructions adapted to allow the administrator to assign administrator privileges to one or more users being added to the file of users.

12. The system for allowing customization of claim 1 wherein the server further comprises instructions adapted to allow the system to display a check mark next to each customization step when it is completed.

13. The system for allowing customization of claim 1 wherein the server further comprises instructions adapted to allow the administrator to add service categories to a list to be resident in the file of categories.

14. The system for allowing customization of claim 1 wherein the server further comprises instructions adapted to allow the administrator to add service subcategories to a list to be resident in the file of subcategories.

15. The system for allowing customization of claim 1 wherein the server further comprises instructions adapted to allow the administrator to add experts to a list to be resident on the file of experts and assign information for the experts to include login and contact information, expertise level and attaching a resume for those experts.

16. The system for allowing customization of claim 1 wherein the server further comprises instructions adapted to allow the administrator to assign to the expert appropriate categories of service from the file of categories.

17. The system for allowing customization of claim 1 wherein the server further comprises instructions adapted to allow the administrator to assign to the expert sub-categories of service from the file of subcategories.

18. The system for allowing customization of claim 1 wherein the server further comprises instructions adapted to allow the administrator to activate any of the experts and change any experts' availability or area of expertise.
